(19) United States
(12) Patent Application Publication
(10) Pub. No.: US 2026/0091922 A1
(43) Pub. Date: Apr. 2, 2026

(54) PACKAGING AND THERMOPLASTIC COMPOSITION FOR PACKAGING

(71) Applicant: RIGENERA DI SFRECOLA COSIMO DAMIANO, Barletta (IT)

(72) Inventors: Nicola DE MATTIA, Matera (IT); Giuseppe DARGENIO, Barletta (IT)

(21) Appl. No.: 19/364,510

(22) Filed: Oct. 21, 2025

Related U.S. Application Data
(63) Continuation-in-part of application No. PCT/IB2024/054306, filed on May 3, 2024.

(30) Foreign Application Priority Data
May 3, 2023 (IT) 102023000008682
Oct. 22, 2024 (IT) 102024000023526
Oct. 31, 2024 (IT) 102024000024558

(51) Int. Cl. B65D 65/42; B29C 48/08; B29K 67/00; B65D 85/34; C08J 3/20; C08J 5/18; C08K 3/013; C08K 5/00; C08K 5/09

(52) U.S. Cl. CPC B65D 65/42; B29C 48/08; B65D 85/34; C08J 3/203; C08J 5/18; C08K 3/013; C08K 5/0058; C08K 5/09; B29K 2067/00; B65D 2205/02; B65D 2565/381

(57) ABSTRACT

A package, in particular a film for food having one or more layers, suitable for making packages capable of increasing the shelf life of fruit and vegetables, is described.

A thermoplastic composition, preferably a biodegradable and compostable thermoplastic composition suitable for making packages for perishable products, for example food products, is described.

Furthermore, some possible embodiments of packaging made of thermoplastic material, in particular of biodegradable and compostable thermoplastic material, suitable for packaging and preserving perishable products, such as food products, are described.

In particular, a flexible package (for example in the form of a film, pouch or bag) and a rigid or semi-rigid package (for example in the form of a clamshell container) are described.

The packages described below are intended, in particular, for the packaging in the presence of air, that is to say in an unmodified atmosphere, of food products, in particular but not exclusively fresh fruit and vegetables and edible mushrooms.

Finally, the use of a combination of zeolites and one or more biocides (organic acids and/or chitosan) to delay the post-harvest ripening of fruit and vegetables is described.

As used herein, the term “food products” comprises fresh fruit and vegetables and edible mushrooms.

As used herein, the term “food products” also comprises sausages and cheeses.

As used herein, the term “perishable products” also comprises fresh floral products.

As used herein, the adjective “thermoplastic” in particular indicates a material that can be moulded under the action of heat and, in particular, a material that can be processed by means of the so-called blown extrusion or flat die extrusion or injection moulding or thermoforming.

The thermoplastic material of the present invention is a material which is suitable for making food packages, that is to say packaging where the packages comes into contact with the food products contained therein.

The thermoplastic material used to provide the packaging described below complies with the requirements of EC Regulation 1935/2004 to which reference is made.

As used herein, the term “fruit and vegetables” comprises both climacteric fruits, that is to say fruits that emit ethylene during the ripening process, and non-climacteric fruits, that is to say fruits that do not emit ethylene during the ripening process.

As used herein, the term “climacteric fruits” comprises, in particular, bananas, peaches, apples, pears, kiwis, persimmons, melons, watermelons, figs, apricots, avocados, plums, papayas, mangoes and tomatoes.

As used herein, the term “non-climacteric fruist” comprises, in particular, strawberries, grapes, cherries, raspberries, pineapple, citrus fruits, cucumbers, green beans, peppers, and asparagus.

As used herein, the term “fresh fruit and vegetables” comprises semi-processed fresh fruit and vegetable such as, for example, washed salad and washed and optionally chopped vegetables.

Preserving fresh fruit and vegetables, for example during their shelf life in the stores or after their retail sale, represents a significant technical challenge.

The period of time during which fruit and vegetables can be preserved without deteriorating, and can therefore remain on the shelves, is known as “shelf life”, also called primary shelf life.

Conversely, the period of time during which the product can be preserved without deteriorating once the original package has been opened by the consumer is known as secondary shelf life (or domestic shelf life).

Several solutions are known to try and maintain an acceptable visual and organoleptic quality of fruit and vegetables for as long as possible and thus extend their shelf life.

For example, it is known to package fruit and vegetables in a protective atmosphere, thus replacing the air inside the package with mixtures of nitrogen, oxygen, and carbon dioxide.

Packaging fruit and vegetables in a protective atmosphere has some disadvantages, not least of which is the need of having an equipment to replace the air inside the package with a mixture of gases having a predetermined composition. Furthermore, once the packaging is opened, the improved preservation effect ceases.

In the food industry, vacuum packaging is also well known.

However, for many fruit and vegetables (mainly for the fruit and vegetable products which are sensitive to crushing, such as lettuce, strawberries, grapes, berries or mushrooms), the pressure exerted by the package on the product causes it to deform and degrades the product presentation.

In the fruit and vegetables packaging industry, the use of perforated packaging is known for preventing the formation of condensation and therefore limiting the proliferation of moulds and bacteria.

However, it has been found that this type of packaging tends to cause progressive dehydration of fruit and vegetables, as well as exposure to external contaminants.

In the fruit and vegetables packaging industry, it is also known to use packaging, for packaging in the presence of air, which are designed in such a way as to be able to absorb substances that accelerate the deterioration of fruit and vegetables and/or release substances that have a positive impact on their shelf life and/or positively interfere with the packaged product, its atmosphere, or the microorganisms present therein.

Such packaging is also commercially known as “active packaging”.

For a definition of active packaging, reference is made to EU Regulation No. 450/2009.

In particular, the use of packages containing zeolites to remove the ethylene that accumulates inside the package following the ripening process of climacteric fruits is already known.

The currently known packages used in the preservation of fruit and vegetables are not entirely satisfactory.

In particular, the currently known packages for perishable products, such as fruit and vegetables, still arise problems in terms of the shelf life of the packaged product.

Furthermore, the currently known packages arise problems in terms of their recovery after use.

Packages made of thermoplastic material incorporating biocidal agents, and in particular inorganic antibacterial agents, directly into the polymers, or rather into the polymer matrix, are known.

ES 1 220 467 U1 discloses an ethylene absorbent plastic sheet for packaging fruit and vegetables.

The disclosed sheet comprises at least three layers made of plastic material, at least one of which incorporates zeolites and potassium sorbate (C₆H₇KO₂, CAS 24634-61-5) in order to absorb ethylene released by the fruit.

The text does not provide any details on the polymer used to make the film and completely ignores the problem of increasing the shelf life of fruit and vegetables that do not release ethylene.

ES 2 939 544 A1 discloses a sheet for packaging fruit and vegetables having at least three layers, at least one of which incorporates zeolites (CAS 12173-10-3) and a mixture of zinc oxides and silver nanoparticles (the latter as antibacterial agents).

In EP'544 the material the sheet is made of is chosen indifferently between traditional polymers such as PP, PET, Polystyrene and biodegradable polymers such as PLAs or PHAs.

Again, the presence of inorganic metal biocides may infringe some regulations such as the UNI EN 13432 regulation.

WO 03/088747 discloses a polymeric film for packaging food products, comprising at least three layers.

At least the layer intended to come into contact with the food products contains antifogging additives (for example a mixture of glycerol monostearate and diethanolamine) and zeolites to reduce the tendency of the film to stick to itself when wound on a reel (antiblocking).

The layer intended to come into contact with the food products can also be loaded with silver ions Ag⁺ to give the film antibacterial properties.

One aim of the inventors is to at least partially solve the problems of the prior art and, in particular, the above-mentioned problems.

In particular, one aim of the inventors is to provide a package for slowing down ripening of fruit and vegetables in general and, in particular, of climacteric and non-climacteric fruits.

A further aim of the inventors is to provide a packaging for perishable products, in particular fresh fruit and vegetables, free, or at least substantially free, from potentially toxic biocides.

It is also an aim of the inventors to provide a package, in particular for fruit and vegetables, having adequate mechanical resistance, in particular adequate resistance to tearing.

A further aim of the inventors is to provide a low-cost package, in particular for fruit and vegetables products.

Some possible solutions for overcoming the drawbacks of the prior art, are described below with reference to the attached drawings in which:

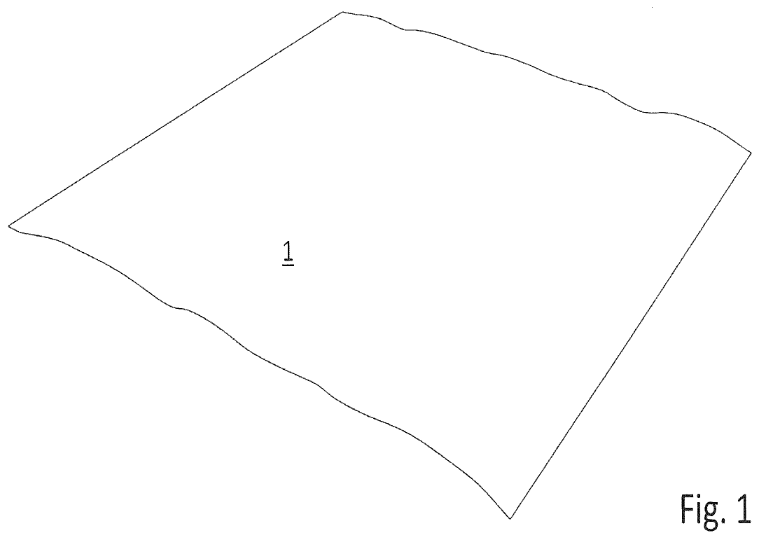

FIG. 1 shows a portion of a film, suitable for packaging and preserving fresh fruit and vegetables:

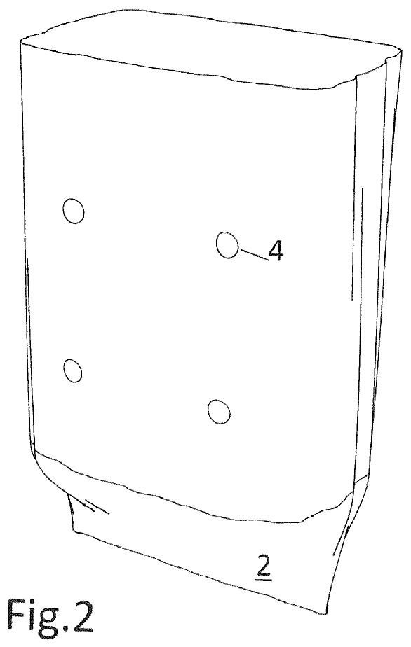

FIG. 2 shows a bag which can be obtained starting from the film in FIG. 1, suitable for packaging and preserving fresh fruit and vegetables; and

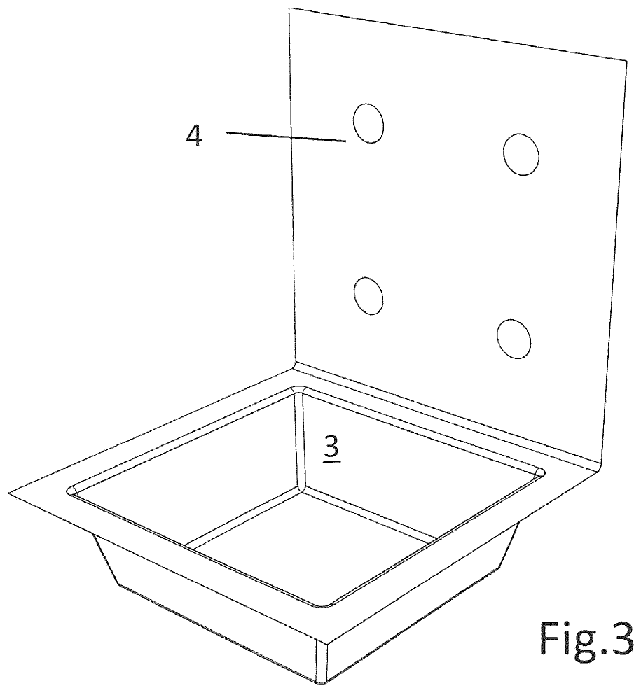

FIG. 3 shows a clamshell container (made by thermoforming) suitable for containing and preserving fresh fruit and vegetables.

With reference to the attached drawings, reference number 1 indicates a package in the form of a film, reference number 2 indicates a package in the form of a bag or a sack (which can be obtained starting from the film 1) and reference number 3 indicates a package of the “clamshell” type.

The packages 1, 2, 3—shown in the attached drawings—are made of a thermoplastic material, in particular a biodegradable thermoplastic material, which will be better described later.

The packages 1, 2, 3 are intended, in particular, for preserving fruit and vegetables in the presence of air.

Fruit and vegetables packaged in packages 1, 2, 3 are preferably preserved in refrigerated conditions (indicatively between 3° C. and 5° C.).

The film 1, for example, can be used for wrapping fresh fruit and vegetables.

The bag 2, for example, can be used for storing fresh fruit and vegetables.

The mouth of the bag 2 can be closed, after inserting fruit and vegetables, for example by making a knot, or by means of bands or simply folding the edges on themselves, or by means of heat sealing.

The clamshell container 3, for example, can be used for storing fresh fruit and vegetables.

The container 3 can be closed by pressure.

The packages 1, 2, 3 described below, are intended in particular for the packaging of fruit and vegetables in the presence of air, that is to say the packaging of the products in an unmodified atmosphere.

As better described below, in some embodiments the packages 1, 2, 3 can be provided with venting holes 4.

In a particular embodiment, the packages 1, 2, 3 are single-layer packages, that is to say they are made with a single layer of thermoplastic material.

In other embodiments, not shown, the packages 1, 2, 3 can be of the multilayer type, that is to say they are obtained by laminating two or more layers, for example two or more layers.

At least the polymer layer which is intended to come into contact with the products to be preserved is added with zeolites and at least one biocide, better described later.

In particular, the film 1 can be obtained by using a conventional single-layer blown extrusion plant, fed with a thermoplastic material in the form of pellets, better described belowr.

Preferably, the film 2 is of the “bi-oriented” type, that is to say it undergoes a stretching process both in the longitudinal and transversal directions, to reach the required thickness.

As used herein, the term “pellet”, refers to granules of plastic material, generally cylindrical or lenticular in shape, preferably with a maximum dimension of less than 5 mm.

The film 1 can be processed in the form of a bag or a sack 2.

The bag 2 can be obtained by using a conventional plant for producing bags fed with a film material, for example a tubular film (in particular a single-layer tubular film), or a single-fold film (in particular a single-layer single-fold film).

The clamshell container 3 (which can be substantially semi-rigid or rigid) can be obtained by thermoforming a sheet of a single-layer material, which is in turn obtained by using a conventional flat-head single-layer extrusion plant, fed with a thermoplastic biodegradable material, in the form of pellet.

The packaged fruit and vegetables are intended to come into direct contact with the material of which the package 1, 2, 3 is made.

As better explained below, the packages 1, 2 and 3 are particularly advantageous for preserving products such as fresh fruit and vegetables, as they can significantly extend their shelf life, regardless of whether or not these fruit and vegetables release ethylene.

The packages 1, 2, and 3 are, therefore, suitable for extending the shelf life of both climacteric and non-climacteric fruit; they are also suitable for preserving partially processed fruit and vegetables, such as washed and possibly pre-cut vegetables.

The packages 1, 2, and 3 can be purchased by the user and used to contain fruit and vegetables to be preserved, products which are purchased separately from the package, to extend the so-called secondary shelf life, that is to say the duration of preservation of the product at the user's premises, for example at home, at a restaurant or at a retailer.

Alternatively, fruit and vegetables to be preserved are marketed already packaged in a package made using the composition described below.

The composition of the pellets used to extrude the material used to make the packages 1, 2, 3 comprises:
at least one thermoplastic polymer for food use, for example at least one thermoplastic polyester polymer;
zeolites; and
a biocidal agent, where this biocidal agent is
   an organic acid, a mixture of organic acids, or
   chitosan, or
   a mixture comprising at least one organic acid and chitosan.

The percentage by weight of zeolites, compared to the total weight of the composition, can be between 0.1% and 2%.

The percentage by weight of the biocide, compared to the total weight of the composition, can be between 00.2% and 10%.

Preferably, the polymer for food use meets the requirements of EC regulation 1935/2004.

The polymers suitable for making the package are heat-sealable and are, therefore, suitable for producing packages in the form of bags.

A thermoplastic polymer suitable for food use can be selected from polyamides (6, 66, 12 and all their copolymers), polyethylene in the various structures (high, medium and low linear density), polypropylene (HOMO, COPO) and film-forming and moulding polyesters.

In any case, the thermoplastic material must meet the requirements of EC regulation 1935/2004 on polymers for food use.

Preferably, the extruded polymer has an amorphous structure, in order to make it more transparent and allow easier visual examination of the packaged product.

Preferably, the thickness of the package 1, 2, 3 is as low as possible, so as to improve transparency.

In a preferred embodiment, the polymer used to make the packages 1, 2, 3 is a polyester.

Even more preferably, the polymer used to make the packages 1, 2, 3 is a biodegradable polyester.

In fact, it has been noted that, all other things being equal, the biodegradable polyester packages 1, 2, and 3 allow a slower ripening of fruit and vegetables to be obtained and/or allow the rotting process of fruit and vegetables to be slowed down.

In the preferred embodiment, the used zeolites are free from metal fillers (such as silver or zinc oxide).

Zeolites can be hydrophobic zeolites, for example hydrophobic zeolites based on aluminosilicates and/or aluminophosphates.

Zeolites and the biocide are distributed in the polymeric mass of the pellet and thus of the material of which the packages 1, 2, 3 are composed.

The used biocidal agents are embedded into the polymer structure and must, therefore, tolerate the polymer processing temperatures required to obtain the pellets extrusion (temperatures that can vary in the order of 120-180° C. depending on the quality of the polymer being processed) without degrading.

As already written, the percentage by weight of zeolites, compared to the total weight of the composition, may be between 0.1% and 2%.

Zeolite percentages greater than 2% by weight lead to a decrease in the transparency of the material of which the package is made and are therefore less preferred.

The term “biocide” or “biocidal agent” is herein intended to indicate one or more organic acids capable of counteracting the proliferation of bacteria and/or mould and/or fungi.

The term “biocide” or “biocidal agent” also comprises chitosan (a linear polysaccharide composed of D-glucosamine and N-acetyl-D-glucosamine).

Organic acids used as biocides are not subject to decomposition in the water.

In the shown examples, the biocidal agent incorporated into the polymeric structure consists of one or more carboxylic acids.

Carboxylic acids are valued because they generally have a considerable thermal stability, thus preventing them from degrading during the extrusion process.

Furthermore, carboxylic acids have poor sensitivity to light and oxygen.

Again, carboxylic acids do not decompose in the water.

In the disclosed embodiments, the composition of the pellets, and thus of the packages obtained by extruding the pellets, is free (or in any case substantially free) from metals or metal-based compounds.

For the purposes of the present description, the characteristic “free from metals or metal-based compounds” can be understood in accordance to the UNI EN 13432 standard, to which reference is made.

In particular, according to the provisions as set forth in chapter A.1.2, the UNI EN 13432 standard indicates the maximum permissible concentrations of Zn, Cu, Ni, Cd, Pb, Hg, Cr, Mo, Se, As, F that may be present in the polymeric material used to make the packages 1, 2, 3.

Since the biocide is free from metals or compounds containing metals, any health risk for those who consume fruit and vegetables that have been packaged in the packages 1, 2, 3 is avoided.

In fact, the packages 1, 2, and 3 come into contact with the food products to be preserved, hence the biocides must be suitable for food use.

Furthermore, since the biocide is free from metals or compounds containing metals, any problems for composting the packages 1, 2, 3 (if the polymer used is a biodegradable polyester) are also avoided.

In a preferred embodiment, the organic acids used as biocides, when in the form of an aqueous solution or emulsion, for example at 1% by weight, are capable of giving the pH a value in the range between 1.5 and 6.5 and preferably between 2 and 5 and even more preferably between 2 and 4.

Since the biocide, in the presence of water, creates an acidic pH further improves the preservation of fresh fruit and vegetables.

Preferred biocidal agents are solid carboxylic acids and, in particular, at least one selected from:
benzoic acid (C₇H₆O₂);
citric acid (C₆H₈O₇); e
sorbic acid (C₆H₈O₂).

It should be noted that the acids listed above (benzoic acid, citric acid and sorbic acid) are used as acids, that is in their non-salified forms, preferably in anhydrous form.

The three acids mentioned above can be present individually and/or in combination.

The three acids mentioned above in particular have excellent antibacterial and antifungal properties.

A preferred biocide/antibacterial is citric acid, which is in solid, powdered form, preferably anhydrous or monohydrate.

In addition to having excellent antibacterial properties, citric acid improves the biodegradability of polyester (when the used polymer is biodegradable polyester).

In a further embodiment, the biocide/antibacterial is or comprises benzoic acid.

In fact, it has been observed that benzoic acid allows the ripening process of fruit and vegetables to be slowed down even at room temperature.

A package containing benzoic acid in the polymer matrix will therefore protect the products contained therein even in the event of interruption or absence of the cold chain.

The antibacterial-biocide may be present in a percentage by weight which is equal to or greater than 0.02%, for example in a percentage by weight which is between 0.02% and 10% by weight of the total weight of thermoplastic polymer (for example polyester), zeolites and biocide (for example one or more carboxylic acids).

Preferably, the biocide is present in a percentage by weight which is between 0.05% and 1.5%.

Even more preferably, the biocide is present in a percentage by weight which is between 0.1% and 1′1%.

The maximum percentage of biocide comprised in the formulation may vary depending on the used organic acids.

For example, the inventors have observed that percentages by weight of citric acid which are greater than 1% tend to cause an excessive increase in the fluidity of the thermoplastic composition during the extrusion phase, making the material production process difficult.

In some possible embodiments (for example when the polymer comprises relatively high percentages of citric acid) the pellet formulation may also comprise calcium carbonate (CaCO₃) powder, so as to avoid an excessive increase in the fluidity values of the extruded polymer.

Calcium carbonate may be present in a percentage by weight which is equal to or greater than 3%, preferably in the range between 3% and 25% and, more preferably, in a percentage by weight which is equal to or greater than 5% in the range between 5% and 15% by weight of the formulation.

Preferably, the percentage by weight of calcium carbonate present in the composition does not exceed 10% by weight of the total weight of the pellet formulation.

In fact, calcium carbonate quantities above 10% reduce the transparency of the package 1.

In case polyesters are used, the additive to control the fluidity of the extruded thermoplastic polymer may consist of or comprise a chain extender for polyesters, for example BASF Joncryl ADR 4400.

The term “chain extenders for polyesters” refers to products which act chemically during the extrusion phase with hydroxylated polymer fractions, allowing the molecular weight and viscosity of the polymer to increase.

The chain extender for polyesters may be present in a percentage by weight which is equal to or greater than 0.5%.

Preferably, the percentage by weight of the chain extender for polyesters does not exceed 2%.

Conversely, sorbic acid does not appear to have any appreciable influence on the fluidity of the thermoplastic composition.

It has been found that the combination of zeolites (for example hydrophobic zeolites) and an organic acid, in particular a carboxylic acid, in a polymeric matrix, in particular polyester, allows the ripening process of packaged fruit and vegetable to significantly delay, regardless of the type of fruit and vegetables present in the package.

In other words, it has been experimentally verified, as reported below, that the combination of zeolites (for example hydrophobic zeolites) and an organic acid (specifically, a carboxylic acid) creates a synergistic effect in delaying the ripening process and thereby extending the shelf life of the packaged fruit and vegetables.

By way of example, the values of the average shelf life of fruit and vegetables when stored in the refrigerator without being packaged (left column) and when packaged in a biodegradable polyester package filled with zeolites and organic acids according to the invention (right column) are summarized below.

TABLE 1

| | | Average shelf life of |
|---|---|---|
| | Average shelf life | fruit kept in the |
| | of fruit kept | refrigerator in a |
| | unpackaged in the | package made according |
| | refrigerator | to the teachings of |
| Type of fruit | (days) | the present patent (days) |
| Apricots | 8 | 15 |
| Pineapple | 7 | 23 |
| Sliced mini | 5 | 14 |
| watermelon | | |
| Avocado | 36 | 50 |
| Sliced avocado | 4 | 13 |
| Banana | 5 | 18 |
| Loto persimmon | 9 | 16 |
| Cherries | 4 | 11 |
| Prickly pears | 12 | 23 |
| Strawberries | 4 | 14 |
| Strawberries (crate) | 5 | 19 |
| Mulberries | 2 | 6 |
| Kiwi | 6 | 12 |
| Lemons | 13 | 30 |
| Tangerines | 7 | 22 |
| Mango | 5 | 50 |
| Cantaloupe melon | 13 | 20 |
| Blueberries | 12 | 22 |
| Loquats | 13 | 19 |
| Pears | 7 | 16 |
| Peaches | 4 | 18 |
| Percoca yellow peach | 4 | 28 |
| Nectarine peaches | 6 | 25 |
| Tabacchina peaches | 4 | 12 |
| Currants | 5 | 13 |
| Plums | 12 | 26 |
| Grapes | 7 | 16 |

TABLE 2

| | | Average shelf life of the |
|---|---|---|
| | Average shelf life | vegetables kept in the |
| | of unpackaged | refrigerator in a package |
| | vegetables kept in | made according to the |
| | the refrigerator | teachings of the |
| Type of vegetables | (days) | present patent (days) |
| Asparagus | 4 | 23 |
| Broccoli | 9 | 18 |
| Artichokes | 3 | 7 |
| Carrots | 12 | 28 |
| Carosello barattiere | 4 | 14 |
| Cauliflower | 4 | 18 |
| Red cabbage | 21 | 42 |
| Cucumbers | 12 | 21 |
| Chicory | 4 | 11 |
| Green beans | 4 | 15 |
| Fennels | 10 | 25 |
| Endive | 6 | 9 |
| Cardoncelli mushrooms | 6 | 27 |
| Lettuce | 4 | 14 |
| Eggplant | 9 | 20 |
| Peppers | 4 | 18 |
| Leek | 12 | 33 |
| Red radicchio | 6 | 9 |
| Radishes | 4 | 15 |
| Spinach | 4 | 13 |
| Cabbage | 12 | 20 |
| Zucchini | 11 | 27 |

In particular, it has been observed that the shelf life of fruit and vegetables is not only extended for climacteric fruit, but also for non-climacteric fruit, where the problem of ethylene released by the fruit does not exist.

In some of the possible embodiments of the packages 1, 2, 3, citric acid, and/or benzoic acid and/or sorbic acid, is present in a percentage by weight which is between 0.05% and 2.0%, preferably between 0.1% and 1.5%, more preferably in a percentage by weight which is between 0.1% and 1%. of the total weight of the polymeric composition.

Preferably, zeolites are present in a percentage by weight of 1.8%-2.0%, and citric acid is present in a percentage by weight of 0.6%-0.8% of the total weight of the polymer composition.

In other embodiments, the biocidal agent consists of or comprises chitosan.

It has been observed that chitosan is particularly effective in counteracting certain types of bacteria, specifically Escheria coli and Staphylococcus aureus.

In some embodiments, the packages 1, 2, or 3 may comprise, in addition to or as an alternative to the organic acid and/or chitosan (incorporated by extrusion), a layer of biocide applied, for example, to one side of the film 1 or to the inner layer of the bag or sack 2 or to the inner side of the container 3.

A layer of biocidal agent may be created on one side of the package, for example, by applying a water-based composition containing a biocide.

This solution may be of interest in case thermolabile biocides are intended to be used, which are unable to withstand temperatures in the range of 120-180° C. and therefore, by their nature, cannot be extruded.

In one possible embodiment, the layer of the biocidal agent applied to the surface of the package 1, 2, or 3 may comprise an essential oil which, when placed in water, for example in an emulsion, creates an acidic pH.

As used herein, the term essential oils with bactericidal action comprises the following oils: tea tree essential oil, lavender essential oil, thyme essential oil, onion essential oil, eucalyptus essential oil, and lemon essential oil, and mixtures thereof.

Additional compounds which can be used as bactericidal/biocidal agents, to be applied to the surface of the package 1, 2, or 3, may be:
bacteriocins;
polyphenols;
terpenes;
peptides; and
cinnaminic aldehyde.

In some embodiments, the film 1 may comprise a plurality of layers made of biodegradable and compostable thermoplastic material, each layer of which is added with zeolites and a biocide for food use.

In other embodiments, the thermoplastic composition comprises, for example, a mixture of citric acid and sorbic acid, the latter of which in fact has not only antibacterial but also antifungal properties.

In not illustrated embodiments, the package 1, 2, and 3 may be multilayered.

In the illustrated embodiments, the package 1, 2, and 3 may be intended for packaging fruit and vegetables in the presence of air.

In the illustrated embodiments, the package 1, 2, 3 does not have barrier layers, that is to say it is free from layers having the function of reducing the permeability of the package wall to water vapour and/or oxygen and/or carbon dioxide.

The special package 1, 2, and 3 is free from layers or coatings containing silicon oxides SiOₓ and/or aluminium oxide Al₂O₃ and/or zirconium oxides ZrO₂ and/or alloisite tubes.

In the case of multilayer packaging, at least the inner layer of the package, for example, the one intended to come into contact with fruit and vegetables, is filled with zeolites and a biocidal agent, such as at least one organic acid (in particular at least one carboxylic acid) or chitosan or a mixture of at least one organic acid and chitosan.

In the case of multilayer packages, at least the layer which is intended to come into contact with the products to be preserved is added with zeolites and organic acids.

The fact that more layers are provided can improve the mechanical properties of the film 1, the bag 2, and the tray 3, particularly it can enhance their resistance to tearing.

The composition of the pellet, and thereby of the packages 1, 2, and 3, may comprise a starch, such as a thermoplastic starch, in a percentage by weight which is less than or equal to 30%.

The composition of the pellet used to make the packages 1, 2, and 3 may comprise a filler dispersing agent, in a percentage by weight which is less than or equal to 1% of the total weight of the polymer composition, to maintain an even distribution of the zeolites and the starch within the extruded product and thereby obtain a material having a homogeneous composition.

The product by the German company BYK can be used as a dispersing agent.

The composition of the pellet, and thereby of the packages 1, 2, 3, may comprise a plasticizer for food use (for example epoxidized soybean oil, glycerin, water, sorbitol or a mixture thereof) to enhance the extrudability and elongation properties of the finished product during the process of bi-orientation of the film.

The percentage by weight of the plasticizer in the thermoplastic composition may be between 0 and 15%.

The pellet with the composition described above can be obtained by introducing all the ingredients, dosed gravimetrically with dedicated dispensers or injected in a known way in case of liquid ingredients, into a conventional extruder, for example a twin-screw extruder.

The extrusion temperatures for extruding the thermoplastic composition described above, at which the film 1 is made, are affected by the type of machine used and the polymer envisaged in the formula.

By way of example, the extrusion temperatures can be between approximately 120° C. and 180° C.

A thermal melting profile which allows to obtain a temperature of the outgoing melted mass of approximately 20° C. above the melt of the compound being processed is generally applied, taking into due consideration the thermolability of the components of the composition.

In a possible embodiment, the single-layer or multilayer film material 1 has an average thickness which is between 7 and 90 μm and preferably between approximately 10 and 20 μm, for example approximately 13 μm.

Average thicknesses which are less than 12 μm can make the film 1 less resistant, in particular less resistant to tearing, and are therefore less preferred.

Conversely, film thicknesses which are greater than 20 μm, while technically good, would be economically disadvantageous and would make the film less transparent.

In a possible embodiment, the material of the clamshell container 3 has an average thickness which is in the range between 0.5 mm and 2.5 mm, preferably at least 1 mm.

In a preferred embodiment, the packages 1, 2, 3 are packages with venting holes 4.

For example, in the case of the packages 2 in the form of a bag or a pouch, the holes 4 can be placed on opposite sides of the bag or of the pouch, while in the case of the clamshell containers, the holes 4 can be located at least on the lid of the container.

The combination of zeolites and venting holes 4, that is to say the holes for the passage of air and gas in general, may at first sight appear to be a contradiction since zeolites are normally used in closed packages, without venting holes.

However, it has been surprisingly observed that the presence of the venting holes 4 on the packages, whether in the form of films, bags, or shells, made of a thermoplastic material filled with zeolites and biocides, further slows down the ripening of fruit and vegetables, particularly (both climacteric and non-climacteric) fruit.

Furthermore, the venting holes slow down the rotting process of fruit and vegetables (especially, but not exclusively, when the package 1, 2, 3 is made of a non-biodegradable material, such as non-biodegradable polyester).

In other words, as experimentally verified and described in the following experimental part, the addition of venting holes 4 on a package 1, 2, 3 made of a composition, for example, with polyesters, zeolites and carboxylic acids surprisingly leads to a synergistic effect on increasing the shelf life of fruit and vegetables and in particular of (non-climacteric and climacteric) fruit.

The inventors hypothesize that the venting holes 4 in particular allow to prevent an excessive increase in the carbon dioxide content inside the package 1, 2, and 3, thus minimizing the anaerobic processes that would tend to degrade the freshness of the fruit and vegetables contained therein.

The inventors also hypothesize that the further slowing down of fruit and vegetables ripening process could also be linked to the fact that the venting holes 4 allow to prevent an excessive increase in the water vapour content inside the packaging, thus minimizing the risk of yeast, mould, and bacterial growth.

For example, using a package preferably made of polyester, filled with zeolites, preferably hydrophobic zeolites, and citric acid and provided with venting holes, the shelf life of the packaged fresh fruit and vegetables increases by at least 80% compared to the shelf life of fruit and vegetables that can be obtained with the packages that use only venting holes, only zeolites or only antibacterial compounds (at the same preservation temperature).

In some cases, the ripening period, that is to say the shelf life of the fruit and vegetable in terms of days before it is no longer saleable, is extended up to four times.

The shape, size, distribution and number of venting holes 4 on the package 1, 2, 3 may vary depending on the size of the package and/or the type of fruit and vegetables contained in the packaging and/or the quantity of fruit and vegetables contained in the package.

In a possible embodiment, the venting holes 4 are circular (or in any case substantially circular) holes and have a diameter which is between 3 and 8 mm and preferably between approximately 4 and 6 mm (that is to say the venting holes have a cross-section which is between approximately 7.065 mm² and 50.24 mm² and, preferably, between 12.56 mm² and 28.26 mm²).

In particular, the venting holes 4 may have a diameter of approximately 6 mm.

The above-mentioned diameter dimensions of the venting holes 4 are considered such that the risk of humidity inside the packaging blocks the holes is unlikely (a problem that arises, for example, by using a small number of conventional venting holes with diameters of 1.5 mm or less), thus preventing the escape of water vapour and carbon dioxide from the package.

In an alternative embodiment, not shown, the venting holes may be oval and have a cross-sectional area of between approximately 7.065 mm² and 50.24 mm² and, preferably, between approximately 12.56 mm² and 28.26 mm².

In general there are at least four venting holes of the type described above for a surface of the film 1 or bag/pouch 2 between 500 cm² and 1200 cm².

By way of example, a rectangular bag 2 measuring 28×42 cm can comprise eight venting holes 4 having a diameter of 6 mm (four for each face or side of the bag).

In a possible embodiment, the holes are present in such numbers and dimensions as to provide a ratio between the area in mm² of the holes per each cm² of the package surface (mm² hole area/cm² surface) which is between 0.04 mm²/cm² and 0.4 mm²/cm².

As seen above, at least four venting holes should preferably be present.

It has been found that, in fact, these values maximize the shelf life of the fresh products contained in the bag 2.

The resulting packages 1, 2, and 3 have an adequate mechanical resistance and are free from risks to the health of the consumers of the packaged fruit and vegetables.

Preferably, the packages 1, 2, 3 are substantially and/or essentially transparent so as to allow a visual examination of the packaged fruit and vegetables.

In the illustrated embodiments, the polymeric material is free from pigments or chromophoric groups, as their presence would hinder the visual examination of the contents of the package (1, 2, 3).

A preferred packaging is a bag or sack made of a polyester film according to the invention.

What the inventors have achieved will now be further illustrated with reference to the following examples.

As discussed above, the technical effect of delayed ripening is achieved with both biodegradable and non-biodegradable polymers, particularly polyester, filled with zeolites and organic acids as described above.

The results on packages made of biodegradable polyester filled with zeolites and carboxylic acids are summarized in Tables 1 and 2.

The following examples show that the delayed ripening effect has been achieved by using a non-biodegradable polyester-based polymer, comparing the shelf life of the plant product in a non-biodegradable polyester container containing zeolites and carboxylic acids fillers compared to the same container without fillers.

### Example 1. Manufacturing of a Polymer Film According to the Invention

In an extruder, 1 kg of CaCO₃, 0.2 kg of zeolites, 0.07 kg of citric acid and 0.1 kg of filler dispersant are added to 10 kg of non-biodegradable filmable polyester to improve the distribution of calcium carbonate, zeolites and citric acid in the polymer mass.

The resulting filled polymer is blown extruded and then transformed into a film having an average thickness of 13 μm.

The same filmable polyester mentioned above, free from zeolites and citric acid, is used to make an identical film.

### Example 2. Peppers Ripening Test

The polyester film obtained in example 1 is used to make bags having dimensions which are equal to 18×28 cm.

Bags with a film containing zeolites and citric acid according to the invention and comparison bags without zeolites and citric acid are made.

The bags comprise 4 holes per side having a diameter of 6 mm.

The bags have been used to package peppers.

The bags have been placed in a refrigerator at an average temperature of 4° C.

It has been found that the peppers packaged in the bag according to the invention have maintained excellent conditions up to the 10th day, while the peppers in a container which was not made according to the invention showed the first signs of wilting already on the 6th day.

### Example 3. White Grapes Ripening Test

The bags made as in example 2 have been used to package bunches of white grapes.

The bags have been placed in a refrigerator at an average temperature of 4° C.

It has been found that the bunches packaged in the non-biodegradable polyester bag filled with zeolites and citric acid have maintained excellent conditions up to the 15th day, while the bunches in a container which was not made according to the invention showed the first signs of wilting already on the 5th day.

Similar results have been obtained using benzoic acid and sorbic acid as biocides.

As previously mentioned, the thermoplastic polymer composition of the invention may be in the form of pellets, film, or a (more or less rigid) container closed with a lid or a film.

The film can have a thickness in the range of 7 to 90 microns, preferably in the range of 10 to 20 microns, for example, 13 microns. The film will have a sufficient thickness (for example approximately 13 microns) to be used to make perforated bags for containing plant products, particularly fruit and vegetables, to be preserved.

Finally, it should be noted that, if biodegradable, the package described is biodegradable even in the absence of ultraviolet rays.

1. A package for packaging fruit and vegetables, comprising:
a) at least one thermoplastic polymer;
b) zeolites, incorporated in said thermoplastic polymer;
c) a biocidal agent, incorporated in said thermoplastic polymer;
c1) said biocidal agent comprising or consisting of at least one organic acid and/or chitosan;
said zeolites being present in a weight percentage of between 0.1% and 2% of total weight of the components a), b) and c); and
said biocide being present in a weight percentage of between 0.02% and 10% of the total weight of the components a), b) and c).

2. The package according to claim 1, wherein said polymer is a polyester.

3. The package according to claim 1, wherein said zeolites are free from metal fillers.

4. The package according to claim 1, wherein said at least one organic acid, when placed in an aqueous solution at 1%, has an acid pH which is between 1.5 and 6.

5. The package according to claim 1, wherein said package does not have barrier layers having the function of reducing the permeability of the package to water vapor and/or oxygen and/or carbon dioxide.

6. The package according to claim 1, wherein said biocidal agent is selected from the group consisting of citric acid, benzoic acid, sorbic acid, chitosan and mixtures thereof.

7. The package according to claim 1, wherein said package comprises a plurality of venting holes (4).

8. The package according to claim 7, wherein said venting holes (4) have a diameter between 4 and 6 mm.

9. The package according to claim 8, wherein said venting holes (4) are present in such numbers and dimensions as to provide a ratio between an area in mm² of the venting holes per each cm² of the package surface (mm² hole area/cm² surface) between 0.04 mm²/cm² and 0.4 mm²/cm².

10. A method for delaying the ripening of plants, said method comprising packaging said plants in a package according to claim 1.

11. Use of a combination of zeolites, free from metal fillers, and a carboxylic acid selected from citric acid, sorbic acid, benzoic acid and mixtures thereof for delaying the ripening of plants including fruit, vegetables, mushrooms and flowers, in a polyester package,.

12. The use of a combination of zeolites according to claim 11, wherein said polyester package includes a plurality of venting holes.

13. The package according to claim 1, wherein said organic acid comprises carboxylic acid.

14. The package according to claim 13, wherein said package does not have barrier layers having the function of reducing permeability of the package to water vapor and/or oxygen and/or carbon dioxide.

15. The package according to claim 13, wherein said biocidal agent is selected from the group consisting of citric acid, benzoic acid, sorbic acid, chitosan and mixtures thereof, and
said package comprises a plurality of venting holes (4) therethrough, said venting holes (4) having a diameter between 3 mm and 8 mm

16. The package according to claim 3, wherein said at least one organic acid, when placed in an aqueous solution at 1%, has an acid pH between 2 and 4.

17. The package according to claim 4, wherein said package does not have barrier layers having the function of reducing permeability of the package to water vapor and/or oxygen and/or carbon dioxide.

18. A method for delaying the ripening of plants, said method comprising packaging said plants in a package according to claim 9.
